(19) United States
(12) Patent Application Publication
(10) Pub. No.: US 2006/0157417 A1
(43) Pub. Date: Jul. 20, 2006

(54) Process for use of rubber powder from tires to remove and recover metals from solutions and effluent gases

(76) Inventor: David L. Wertz, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/320,533

(22) Filed: Dec. 28, 2005

Related U.S. Application Data
(60) Provisional application No. 60/640,570, filed on Dec. 30, 2004.

(51) Int. Cl. C02F 1/28

(52) U.S. Cl. 210/688; 210/912

(57) ABSTRACT

Heavy metals are removed from a stream by contacting the stream with tire derived powder and separating the powder from the stream.

This application claims the benefit of provisional application Ser. No. 60/640,570 filed Dec. 30, 2004.

### BACKGROUND OF THE INVENTION

The present invention relates to processes for removing contaminants from waste streams and other surface water. More particularly, the present invention relates to the use of tire-derived powder to remove contaminants such as heavy metals.

Currently, about two hundred million scrap tires are being stockpiled, land filled or being illegally dumped annually with about one hundred million scrap tires being recycled in a variety of ways. Billions of scrap tires have previously been landfilled, where they remain. The current disposal methods are causing numerous short-term environmental problems. For example, whole tires occupy large amounts of space, and may “float” or rise to the top of landfills. In an attempt to prevent floating, many landfills require that scrap tires be shredded, a process which is energy intensive and wasteful if it does not produce any useful product.

Scrap tire stockpiles produce health risks by providing a place for rodents and mosquitoes to breed which facilitates the spreading of diseases. Large fires have also broken out in scrap tire stockpiles causing many problems. These fires are long lasting and are difficult to extinguish, unnecessarily tying up fire fighting resources. Additionally, these fires produce unwanted smoke which pollutes the environment and toxic oils which poison adjacent soils and water.

Numerous attempts have been made to develop processes to use or recycle scrap tires. One such process is disclosed in U.S. Pat. Nos. 5,889,063 and 6,060,528, the teachings of which are incorporated wherein by reference. These patents disclose a process for creating rubber particles. These particles can be referred to as tire derived powder (“TDP”).

TDP can be formulated into pellets that are useful as a fuel source. Additionally, they have found uses in soil compaction as well as pyrolysis. However, it would be an advancement in the art to develop other uses for TDP. Such uses are disclosed and claimed herein.

### SUMMARY OF THE INVENTION

The present invention provides a method and composition for collecting and concentrating metal cations from various fluid streams. The TDP can be used to extract metal cations from municipal waste streams, mine runoff, industrial wastewater and effluent gases.

### DETAILED DESCRIPTION OF THE PREFERRED EMBODIMENTS

Tire-derived powder (“TDP”) exhibits the ability to collect and concentrate metal cations, thus removing these metal cations from other media. TDP can be obtained from the processes disclosed in U.S. Pat. Nos. 5,889,063 and 6,060,528, the teachings of which are incorporated herein by reference.

TDP has been shown through experimental testing to remove metal cations from solution. Wavelength dispersive x-ray fluorescence spectrometry (“WDXRF”) is a preferred method of establishing the presence of metal cations in any medium. WDXRF is based upon the principal of separating the X-rays produced by the elements in the sample and then identifying the elements which produce the characteristic X-rays using Moseley's law. The correlation of x-ray wavelength with the identity of an element is well known and has been published in many books and manuscripts.

Further, the methodology may be extended to provide a quantitative measure of each metal species using the equation:
% A=[P_{A}−b_{A}]/m_{A}

wherein
% A is the percentage by mass of cation (analyte) A,
P_{A} is the peak height of the x-ray peak due to the analyte A, and
m_{A} and b_{A} are the slope and the intercept, respectively, measured for each analyte A via use of a series of mixtures of known composition containing analyte A.

The invention is better understood by reference to the following examples:

### Examples 1-7

A series of solutions, each containing a different cation, were prepared. TDP samples were disbursed into each solution. After 60 minutes, the treated TDP was recovered from each solution by gravity filtration. It was then dried and submitted to WDXRF analysis. A sample of untreated TDP, serving as a “baseline” was also analyzed by WDXRF.

All spectra were obtained using a modified Rigaku S-Max spectrometer with modern digital updates. A rhodium end-centered x-ray tube was used as the exciting radiation. A PET crystal (d=4.375 Å) was used to disperse the X-rays emitted by the sample. The dispersed secondary X-rays were collected and “counted” via a gas-proportional counter using P-10 gas.

Table 1 shows the results of these experiments. The second column identifies the analyte that was tested, the third column contains the concentration of the analyte in the test solution, the fourth column contains the peak height and abundance of each of the analytes in the untreated TDP and the fifth column shows the peak height and abundance of each of the analytes in the treated TDP.

TABLE I
RESULTS OF THE WDXRF MEASUREMENTS OF TDP SAMPLES
TREATED IN THE SEVERAL ONE-CATION SOLUTIONS.

| | | CON- | PEAK HEIGHT AND | |
|---|---|---|---|---|
| | | CENTRATION | ABUNDANCE | |
| | | OF ANALYTE | UNTREATED | TREATED |
| | ANALYTE | IN SOLUTION | TDP | TDP |
| Ex 1 | Hg⁺² | 0.01 molar | <LLD | 15,500 (2.7%) |
| Ex 2 | Pb⁺² | 0.01 molar | <LLD | 40,850 (6.1%) |
| Ex 3 | Cu⁺² | 0.01 molar | 1,650 (0.2%) | 22,100 (2.2%) |
| Ex 4 | Co⁺³ | 0.01 molar | <LLD | 21,400 (1.5%) |
| Ex 5 | Ca⁺² | 0.01 molar | 725 (0.001%) | 12,600 (2.2%) |
| Ex 6 | K⁺ | 0.01 molar | <LLD | 49,600 (7.1%) |
| Ex 7 | Ag⁺ | 0.01 molar | <LLD | 7,300 (1.1%) |

The linear correlation equations used to correlate the peak height of each specific x-ray peak to the abundance of the specific cation used in this study are listed in Table II.

TABLE II
LINEAR CORRELATION OF PEAK HEIGHT OF X-RAY PEAK FOR
EACH ANALYTE WITH THE ABUNDANCE OF THAT ANALYTE.

| | | |
|---|---|---|
| % Ca = | Peak Height in CPS/18,825 CPS for the peak at λ = | 3.36 Å. |
| % Cu = | Peak Height in CPS/21,545 CPS for the peak at λ = | 1.54 Å. |
| % Co = | Peak Height in CPS/24,546 CPS for the peak at λ = | 1.79 Å. |
| % Hg = | Peak Height in CPS/7,893 CPS for the peak at λ = | 1.23 Å. |
| % Pb = | Peak Height in CPS/12,332 CPS for the peak at λ = | 1.54 Å. |
| % Ag = | Peak Height in CPS/6,651 CPS for the peak at λ = | 4.13 Å. |
| % K = | Peak Height in CPS/6,944 CPS for the peak at λ = | 3.74 Å. |
| % Br = | Peak Height in CPS/9,429 CPS for the peak at λ = | 1.09 Å. |

As can be seen by reference to Table I, each of the metal cations which were placed in solution adhere to TDP. Accordingly, TDP can be used for the removal of these species from solution and further concentration for subsequent uses.

### Example 8

A solution of five cations was prepared and treated using the same procedures as in Examples 1-7. The results of the WDXRF measurements of the TDP sample treated in the five cation solution are set forth in Table III.

TABLE III
RESULTS OF THE WDXRF MEASUREMENTS OF TDP SMAPLE
TREATED IN THE FIVE-CATION SOLUTION.

| | | PEAK HEIGHT AND | |
|---|---|---|---|
| | CONCENTRATION | ABUNDANCE | |
| | OF ANALYTE | UNTREATED | TREATED |
| ANALYTE | IN SOLUTION | TDP | TDP |
| Hg⁺² | 0.01 molar | <LLD | 26,500 (3.4%)^{a} |
| Pb⁺² | 0.01 molar | <LLD | 45,500 (3.7%)^{a} |
| Cu⁺² | 0.01 molar | 1,650 (0.2%) | 10,700 (0.5%) |
| Co⁺³ | 0.01 molar | <LLD | 8,800 (0.4%) |
| Ca⁺² | 0.01 molar | 725 (0.001%) | 72,200 (4%) |

^{a}The characteristic peaks due to mercury and lead overlap, and they have been resolved using graphical methods. Consequently, each abundance reported in this table may be in error by ±25%, but the total abundance of these two elements, taken together, is ˜7.0%.

Again, it can be seen that all of the metal cations adhere to the TDP. There does not appear to be any competition for sequestering the different cations onto the TDP.

### Example 9

Municipal and industrial wastes frequently contain heavy metals such as arsenic, cadmium, chromium, copper, nickel, mercury, lead and zinc. The abundances of the heavy metals in these wastes are usually too low to make their recovery commercially feasible. However, the abundances are sufficiently high at times to cause specific physiological damage.

The present invention can be used to remove these heavy metals from solution. A municipal waste stream is brought into contact with tire-derived powder for a period of time sufficient to permit sequestration of toxic heavy metals onto the tire-derived powder. The powder is then separated from the waste stream. The heavy metals can be recovered from the tire derived particles using conventional chemistry and electrochemistry. The waste stream is then further processed using conventional techniques.

### Example 10

In a typical mining operating, particulate matter (silt) containing metals is produced. This particulate matter eventually becomes dispersed into surface water where it is frequently toxic to numerous aquatic species because of the heavy metals contained in the silt particles. In order to remove the heavy metals, mine runoff is directed to a containment reservoir which is lined with tire-derived particles. The dispersed toxic metals form addicts with the tire-derived powder and the purified surface water can then be released from the containment facility.

### Example 11

Flue gases which result from the combustion of coal contain very low abundances of several metals, of which, mercury is the most harmful. A mercury containing flue gas is passed through a bed of tire-derived powder on a continuous basis. Mercury and other heavy metals contained in the flue gas are sequestered on the tire-derived particles.

While the invention has been described with respect to the presently preferred embodiments, it will be appreciated by those skilled in the art that changes and modifications can be made to the invention without departing from the scope thereof.

What is claimed is:

1. A method for removing heavy metals from water comprising:
contacting water containing heavy metal ions with tire derived powder; and
separating the tire derived powder from the water.

2. A method for removing heavy metals as defined in claim 1 further comprising recovering heavy metals from the tire-derived particles.

3. A method for removing heavy metals as defined in claim 1 wherein the water comprises a municipal or industrial waste stream.

4. A method for removing heavy metals as defined in claim 1 wherein the water comprises mine runoff.

5. A method for removing heavy metals as defined in claim 1 wherein the water comprises industrial wastewater.

6. A method for removing heavy metals from effluent gases comprising:
contacting effluent gases containing heavy metal ions with tire derived powder; and
separating the tire derived powder from the gases.

7. A method for removing heavy metals from effluent gases as defined in claim 6 further comprising recovering heavy metals from the tire-derived particles.
